(19) United States
(12) Patent Application Publication
(10) Pub. No.: US 2007/0062059 A1
(43) Pub. Date: Mar. 22, 2007

(54) Deflector plate for kilns

(75) Inventor: Jenifer L. Miller, Livonia, MI (US)

Correspondence Address: WATTS HOFFMANN CO., L.P.A.;Suite 1750, 1100 Superior Avenue, Cleveland, OH, 44114-2518, US

(73) Assignee: COE MANUFACTURING COMPANY

(21) Appl. No.: 11/506,996

(22) Filed: Aug. 18, 2006

Related U.S. Application Data
(60) Provisional application No. 60/710,689, filed on Aug. 23, 2005.

(51) Int. Cl. F26B 25/06; F26B 19/00

(52) U.S. Cl. 34/202; 34/218

(57) ABSTRACT

One or more perforated deflector plates are used in a kiln to deflect a portion of the air that encounters the plate while allowing the rest of the air to flow through the plate, allowing for more flexibility in controlling air flow throughout the kiln. The position of the plate and the degree of perforation of the plate can be adjusted to achieve improved air flow for a particular kiln.

### CROSS-REFERENCE TO RELATED APPLICATION

This application claims priority from Provisional Application Ser. No. 60/710,689, filed on Aug. 23, 2005. Provisional Application Ser. No. 60/710,689 is incorporated in its entirety herein by reference.

### TECHNICAL FIELD

The invention relates generally to the field of drying kilns for use with lumber and more particularly to devices for routing air flow through such kilns.

### BACKGROUND

A lumber dry kiln consists of one or more chambers designed to provide and control the environmental conditions of heat, humidity, and air circulation necessary for the proper drying of wood. As the development of the modem dry kiln has progressed, a number of design modifications have been explored in relation to the mechanism of heat supply, arrangement, and type of fans, control of relative humidity or wet-bulb temperature, and use of various materials for construction of the chamber.

To dry lumber, air of controlled temperature and humidity is passed uniformly over its surface. This circulating air is the “workhorse” of the dry kiln. As such, the air performs two functions: it carries heat to the wood to effect evaporation, and it removes the evaporated water vapor. Effective and uniform circulation of air involves several factors: the size, location, and speed of the fans to drive the air; provision for reversal of air circulation; installation and use of baffles to direct the air through the load; and placement of stickers within the load to facilitate the movement of air across each piece of lumber.

Uniformity in the amount of drying that occurs in the lumber in a kiln is a critical component of kiln operation. Typically, after drying a kiln load, some wood is too dry and some is too wet. Over-dried wood is degraded and therefore less valuable. Over-dried wood is brittle and often breaks into pieces in the infeed to the planer, causing planer jams that require that the planer be stopped for about ten minutes (at a lost operation cost of about $50 per minute) to clear the obstruction. Under-dried wood can be sent back to the kiln for more drying. This re-drying incurs sorting costs as well as the time spent reloading the kiln and use of kiln capacity that could be used to dry additional wood. Under-dried wood that is sent to the planer also causes planer jams and has degraded value due to its wet condition.

### SUMMARY

Achieving more uniformity in drying reduces the quantity of over-dried and under-dried wood thereby increasing the value of the lumber, reducing planer downtime, increasing the efficiency of kiln use, and reducing kiln costs per unit of wood that is dried.

One or more perforated deflector plates are used to deflect a portion of the air that encounters the plate while allowing the rest of the air to flow through the plate, allowing for more flexibility in controlling air flow throughout the kiln. The position of the plate and the degree of perforation of the plate can be adjusted to achieve improved air flow for a particular kiln.

### BRIEF DESCRIPTION OF THE DRAWINGS

FIG. 1 is schematic cross section view of a kiln constructed in accordance with one embodiment of the present invention; and

FIGS. 2A and 2B are detailed views of a perforated deflector plate shown in FIG. 1.

### DETAILED DESCRIPTION

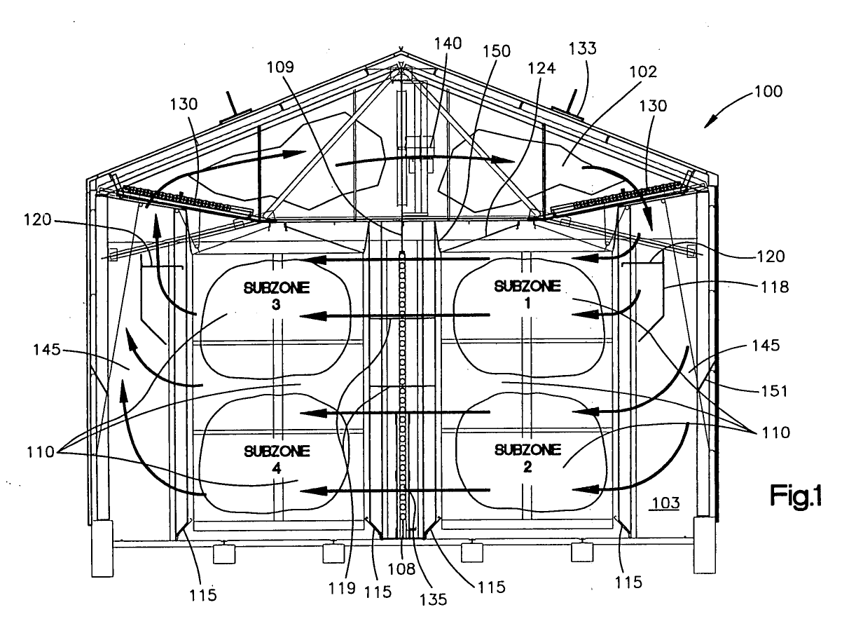

FIG. 1 is a schematic cross section of a steam heated kiln 100 that will be used for the purposes of this description. As will be apparent to those of skill in the art, the air flow techniques and devices disclosed herein can be advantageously implemented in any number of kiln types that would benefit from improved air flow.

The kiln 100 is divided into zones into which stacks of lumber 110 are placed. As will be described in more detail here, various heat and humidity sources as well as air flow directing devices are configured to control the environment in each zone separately, with an aim to making the environmental conditions across zones more uniform. Four subzones 1-4 of one zone of the kiln are labeled in FIG. 1. Additional zones are present in the kiln behind and/or in front of the zone shown in FIG. 1. Divider walls 102 and 103 divide the shown zone from the zone behind. The divider walls may include doors to provide access to the various zones and to allow air flow between zones if that becomes necessary. The air flow throughout the kiln in one mode of operation is indicated by arrows. One or more fans 140 move air through the kiln 100, drawing on fresh air when necessary through vents 133. The direction of the fan blades is changed regularly between clockwise and counterclockwise to even out differences in drying due to air flow direction. A plenum chamber 145 is formed on either side of the kiln by the kiln wall and the lumber stack. The air from the fans passes into the plenum chamber to even out the air pressure prior to passing through the lumber stacks. The air in the kiln is heated when it passes over steam heating coils 135 in the center of the kiln and heating coils 130 in the top cavity of the kiln.

To direct the flow of air through the kiln, air routing and deflecting devices are utilized. To provide uniform drying, the optimal air flow path is from the fan 140 through the heating coils 130, into plenum chamber 145, through the first set of lumber 110 horizontally as indicated by the arrows, through center coils 135 for reheating and then through the second set of lumber 110. Air flow above and below the stacks is to be avoided and air temperature and flow rate through each zone and subzone should be as uniform as possible. To achieve these goals, provided are overhead baffles 124 having curtains 150 that are adjustable and can be positioned so that they nearly contact the top of the lumber stack to prevent unheated air from flowing across the top of the top stacks and causing uneven drying. Floor baffles 115 prevent flow beneath the lumber stacks. Center coil and fan deck baffles 108, 109 prevent flow around the heating coils 135. Plenum deflectors such as 118 and 151 and center deflectors 119 deflect air horizontally through the stacks.

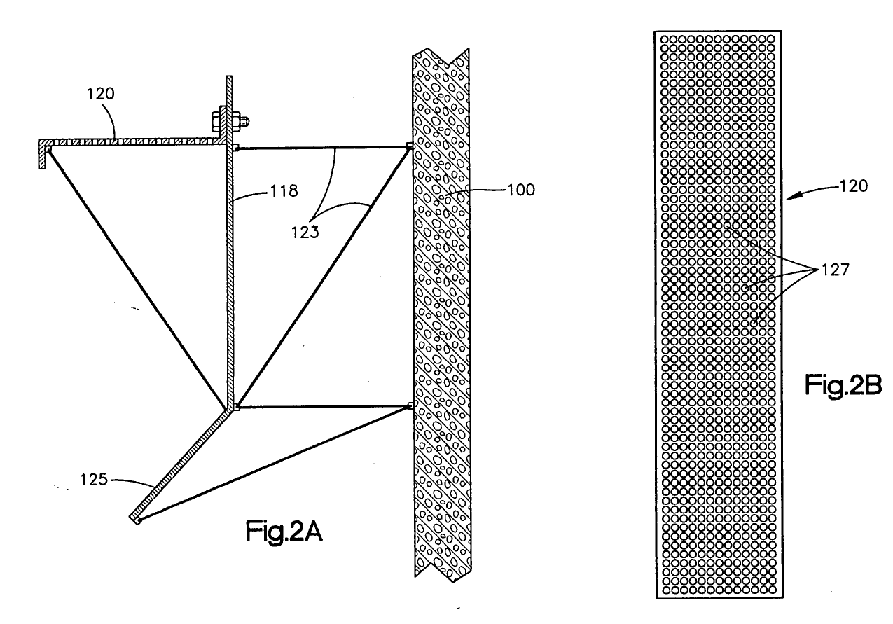

One challenge in directing air through the kiln is to direct air into the top outer comer of the first subzone encountered by the air. To address this difficulty, the plenum deflector 118, shown in detail in FIG. 2A, advantageously features a perforated plenum deflector plate 120 (FIG. 2B) that serves to sharply deflect some of the air into the top comer of the lumber stacks and allow the remainder of the air to flow down to be deflected by a second deflector feature 125 into the bottom of the top layer of lumber and the top of a second layer of lumber. The perforated plenum deflector plate 120 is bolted to the plenum deflector 118 which is supported by structural members 123 attached to the kiln 100. The perforated plate described herein has a perforation rate of 50% with 1.5 inch diameter holes 127. Other perforation rates and methods of perforation such as grating or expanded metal could be used as well. An additional advantage of the perforated plenum deflector plate is that it will not accumulate water from the humid kiln environment.

We claim:

1. A lumber-drying kiln comprising:
an air moving device that circulates air through the kiln;
a heat source that heats the air;
one or more drying zones into which lumber is placed;
one or more plenum chambers surrounding the drying zones through which air is circulated;
one or more air deflectors comprising perforations such that the air deflector deflects a portion of the air that encounters the air deflector while allowing some of the air that encounters the air deflector to pass through the air deflector substantially undeflected.

2. The lumber-drying kiln of claim 1 wherein the air deflector comprises a perforated plate.

3. The lumber-drying kiln of claim 1 wherein the air deflector has a perforation ratio of fifty percent.
